(19) United States
(12) Patent Application Publication
(10) Pub. No.: US 2008/0181097 A1
(43) Pub. Date: Jul. 31, 2008

(54) METHOD AND OFDM RECEIVER WITH MULTI-DIMENSIONAL WINDOW PROCESSING UNIT FOR ROBUSTLY DECODING RF SIGNALS

(75) Inventors: Steven J. Goldberg, Downingtown, PA (US); Inhyok Cha, Yardley, PA (US); Prabhakar R. Chitrapu, Blue Bell, PA (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/938,365

(22) Filed: Nov. 12, 2007

Related U.S. Application Data
(60) Provisional application No. 60/866,101, filed on Nov. 16, 2006.
(60) Provisional application No. 60/869,023, filed on Dec. 7, 2006.

(51) Int. Cl. H04J 11/00; H04L 27/28

(52) U.S. Cl. 370/210; 375/260

(57) ABSTRACT

The invention enhances channel correction techniques for orthogonal frequency division multiplexing (OFDM) systems so that higher effective data rates can be achieved with a minimal processing load. OFDM channel values determined due to known sequences in one domain can be used to seed solution matrices for channel value determination in other domains. This method can be applied to multiple-input multiple-output (MIMO) systems in order to deal with signal distortion while maintaining a reasonable processor loading profile. In another embodiment, a method to optimize channel partitioning during channel estimation processing in an ultra-wide band (UWB) OFDM wireless communications network includes creating a plurality of windows across a time-frequency channel plane, adaptively sizing the plurality of windows, and merging the plurality of windows.

### CROSS REFERENCE TO RELATED APPLICATIONS

This application claims the benefit of U.S. Provisional Application No. 60/866,101 filed Nov. 16, 2006, and U.S. Provisional Application No. 60/869,023 filed Dec. 7, 2006, which are incorporated by reference as if fully set forth.

### FIELD OF INVENTION

The invention is related to a wireless communication receiver.

### BACKGROUND

Orthogonal frequency division multiplexing (OFDM) is a modulation technique for transmission based upon frequency-division multiplexing (FDM), where each frequency channel carries a separate stream of symbols. The carrier frequencies are chosen so that the frequency bands of the channels are orthogonal to each other, which allows for high spectral efficiency. FIG. 1 shows that the peaks of each channel modulation are at the zero values for all other channel modulations.

If signals in different channels are received with the orthogonal characteristic intact, there is no co-channel interference between the channels, and their decoding will be hampered only by interference sources and channel induced distortions. However, the orthogonal signal transmission can be received disturbed due to frequency offset errors and phase noise. Relative physical movement between the transmitter and receiver is the most severe source of these detrimental effects. Telecommunication standards support services that typically are short distance services and do not have high relative physical movement. Thus, their sources of error will tend to be due to channel conditions, frequency lock errors, and low channel coherence across time and or frequency.

FIG. 2 shows the same channels as FIG. 1, but with carrier frequency offsets differing from the ideal values, resulting in co-channel interference (CCI). This can be observed by comparing the zero crossing lack of coincidence and the undulating nature of the sum of the signals, as shown in FIG. 2. In reality there will also be complex channel gain induced changes which can differ across each channel, and received carriers can bear little resemblance to the still visually identifiable channels of FIG. 2.

There are of course additional distortions due to interference from other transmitters and noise sources. Thus, there is a need to process the received signals to correct for propagation induced distortions and ultimately extract the individual desired signal streams.

The prior art approaches mostly have to do with combinations of suppressing unwanted signals, correcting the characteristics of the wanted signals, and making the mostly likely choice as to the transmitted data.

The use of a pilot, (i.e., training), transmissions is an often used approach to determining corrective signal processing means. Since pilot symbols occur in known times and frequencies in transmissions, the receiver can compare what is received to what was transmitted. The receiver can therefore determine how to process the received signal to correct for the distortions.

High-performance demodulation of OFDM signals requires accurate and sufficiently frequent characterization of the time-frequency channel that the signals experience. Once channels are fully characterized or, equivalently, “estimated”, such channel estimates can be used to maximize the effects of the channels in optimum demodulation of signals that went through the channels. Typically, this process is called “channel equalization”.

In modern wireless communication systems, where OFDM is the modulation of choice, such as the European Computer Manufacturers Association (ECMA)-368 ultra-wideband (UWB) personal area networks (PAN) systems, the characterization of the channels is typically performed by having two sets of signals.

The first signal is called the preamble, and its signal composition is fully known at the receiver on all time and frequency samples that comprise the preamble signal. Preambles are typically pre-pended before the data part of a packet. Using interpolation of channel estimates obtained from adjacent packets' preambles, an estimate may be obtained of the time-frequency channel that the data part may experience.

The second type of signal that is useful in further assisting channel characterization and eventual equalization are the pilots. The pilots are known signals that occupy a subset of the entire time-frequency sample space of the post-preamble part of a packet, and typically comprise multiple single or small-subset samples that are regularly dispersed in the time and frequency sample space of the post-preamble part of a packet. Again, using interpolation among the pilot samples, and/or using also the preamble parts, one can obtain an estimate of the channel.

FIG. 3 depicts several conventional procedures of inserting, (i.e., distributing), pilots across a time-frequency channel space of interest. The pilots are the dark rectangles, and the clear squares are data. The left most approach periodically inserts pilot symbols amongst the data. The corrective techniques are determined during the pilot instances and applied to the data during their occurrences. The basic assumption being that the distortions that occur during the data periods are sufficiently close to those determined from the pilot symbols. The middle approach continuously generates pilot tones in some of the parallel channels. It is assumed that the variance between the pilot tones in the frequency domain is once again low so that the corrective actions for the pilots will be adequate for the data channels. Finally, the most general approach is shown in the right most part of FIG. 3, where there is a mixture of symbols and tones scattered amongst the channels. The concept of this approach being that the coherence in time and frequency of the distortions is variable and it is best to exploit both means of determining corrective processing. If the coherence across one dimension, (i.e., time or frequency), is inadequate, it may be adequate across the other dimension. The exact means to exploit the pilots is outside the scope of this disclosure.

Another approach, which in its pure form does not require pilots, is to use a blind signal separation technique. The “blind” adjective refers to the fact that the signals are separated without some information required by the classical techniques. A lack of a pilot sequence, or the inability to decode it, for instance does not allow the comparison of a known signal to a received signal. The channel effects on the signal therefore can not be directly determined.

Blind signal separation techniques get around this lack of information by exploiting information that still exists in the various signal types. One such type of information is the moments of the signals. Different communications stream sources impart different values to these moments. By maximizing a cost function based on the unique values of these parameters due to each signal, a separation matrix may be determined which will extract each signal from the mixture.

Two other specific implementations of a blind technique applied to OFDM are given also known in the prior art. The first performs the function in the frequency domain, and the second in the time domain.

The processing may also be performed with and without pilots by approaches such as least mean squares estimation (LME), zero forcing (ZF), and minimum mean square error estimation (MSEE).

The blind and non blind techniques listed above are often iterative intensive in nature, and their practicality is often limited by the number of iterations required to obtain a converged solution.

Simulations for non-multiple-input multiple-output (MIMO) modulations indicate the independent component analysis (ICA) type of blind processing are under certain circumstances equivalent to the linear minimum squared error estimate (LMSEE) approach. There are however approaches which achieve results close to the LMSEE approach and are often less computationally intensive then ICA. This reiterates the prior discussion that if pilots are available and the coherence of the channels is adequate, then a non-blind approach should be utilized.

An additional approach addresses the problem of having pilots, but the coherence time of the channel is inadequate for the robust correction of the channel distortions. For a brief explanation of this approach, FIG. 4 shows the basics of one of its implementations.

As shown in FIG. 4, processing suitable for pilots (referenced as “training sequences”) and data are performed as appropriate. The overall processing load however is mitigated by the fact that the results from one form of processing are used to seed the processing stage for the other form of processing.

As shown in FIG. 5, a study was performed which showed at least for one type of modulation, a significant reduction in processor loading. The reason for this reduction can be explained by the fact that these processing techniques are iterative in nature, and the closer the initial solution is to the final answer, the fewer the number of iterations that are required. As can be seen, the seeding causes the number of iterations to be reduced by a minimum factor of four to one.

Both the non-blind and blind approaches have their appropriate application scenarios. When there is knowledge concerning the signal components, a non blind approach exploiting pilots will usually be the one requiring a lower processing load as compared to the blind technique. When knowledge is not available, the receiver's default approach can be a blind technique. Nothing prevents the blind approaches from operating on training and data portions of the streams in the same processing block, but they do not explicitly exploit the fact that some of the processing is being performed on training sequences and tailor the processing to gain from these occurrences.

The general problem with the pilot approaches is that they assume a degree of coherence in the channel distortions during the data's processing. The most basic use of pilots is to determine an average value and use it on the data. FIGS. 6A and 6B show a slightly more sophisticated approach, which is to use pilots on either side (i.e., time or frequency) of the data and interpolate the value depending on how close they are to a particular pilot. As show in FIG. 6A, such an approach gives a reasonably accurate value at various instances of the data. However, the approach shown in FIG. 6B has significant errors in the value that will be used to correct (often called equalize) the signals.

An alternative prior art approach which uses nonlinear techniques is also known. The problem with all interpolation approaches is that the propagation conditions can change at a speed or in a fashion that leaves the calculated result being a poor value relative to the actual one.

A means to compensate for the fact that the determined correction values are not perfect for various channel parameters is to adjust the parameters used to encode the data. Information bits must be adaptively distributed in order to optimally exploit available channel capacity that changes dynamically, is partially addressed in the prior art by the use of adaptive modulation coding (AMC). In AMC, the transmitter adaptively selects one of many modulation and coding schemes, usually changeable per packet basis, depending on the quality of the channel which the transmitter anticipates its transmitted packet will go through. In the ECMA-358 UWB systems, for example, there are 8 different AMC modes that provide, on a per packet basis, an adaptive method to allocate bits across a packet.

Table 1 below depicts the data rates available in the ECMA-368 AMC modes. In general, a lower coding rate (i.e., data/all symbols) and a lower coded bit per symbol rate improve the likelihood of correct decoding in the presence of signal distortion. The distortion could of course also be due to factors such as noise or interferers, which is not directly addressed by the compensating for the channel parameters. It is indirectly addressed in that the compensation is biased towards the desired signals and probably makes the undesired more randomized. The negative of using either approach is that the effective data rate is impacted as shown in the left most column of Table 1.

TABLE 1

| | | | | | Coded Bits/ | Info Bits/ |
|---|---|---|---|---|---|---|
| | | | | | 6 OFDM | 6 OFDM |
| Data Rate | Modu- | Coding | | | Symbol | Symbol |
| (Mb/s) | lation | Rate (R) | FDS | TDS | (N_{CBP6S}) | (N_{IBP6S}) |
| 53.3 | QPSK | 1/3 | YES | YES | 300 | 100 |
| 80 | QPSK | 1/2 | YES | YES | 300 | 150 |
| 106.7 | QPSK | 1/3 | NO | YES | 600 | 200 |
| 160 | QPSK | 1/2 | NO | YES | 600 | 300 |
| 200 | QPSK | 5/8 | NO | YES | 600 | 375 |
| 320 | DCM | 1/2 | NO | NO | 1200 | 600 |
| 400 | DCM | 5/8 | NO | NO | 1200 | 750 |
| 480 | DCM | 3/4 | NO | NO | 1200 | 900 |

Another approach is to shorten the distance between training sequences and data. One example has a preamble, (a physical layer convergence protocol (PLCP)), which can be used for training purposes. The data portion of the subsequent frame sequence (physical layer service data unit (PSDU)) is variable in length (N-frame). Using a shorter data packet places the training sequence of the preamble closer in time to the data. The negative of such an approach being that the ratio of header time and pad bits to data time (i.e. Overhead) has been increased, once again decreasing the optimum data rate of the link.

Yet another method of the prior art addresses the coherence limitations for pilot derived correction factors and the processor loading for modulations with pilots distributed sequentially in time with data. It does not however address the issue for OFDM systems when some or all of the pilots are in other frequency channels.

While many of the techniques mentioned in the prior art section are theoretically capable of providing robust determination of the channel distortion characteristics, their practicality is limited by the processing necessary for their implementation.

There is therefore a need to improve the channel correction techniques for OFDM systems so that higher effective data rates can be achieved, and to do so with a processing load that is practical in a cost effective product.

One problem associated with the prior art is related to the fact that the wireless channel changes relatively fast, even over the short duration of a packet. Such changes can occur due to various reasons, such as fast physical movements of the wireless transmit/receive units (WTRUs), rapid changes in environments, and/or sudden changes in physical characteristics of the transmitters or receivers. The ‘change’ in the channel can be defined as a change in either or both the time domain or the frequency domain. When the change is eminent in the time domain, a channel is typically defined as having a very short coherence time. When the change is eminent in the frequency domain, such a channel is typically defined as a frequency-selective or spectrally-colored channel. Even if interpolation is used over the two most adjacent known parts of a signal, such as two adjacent pilots, if the channel faces very rapid changes, the resulting channel estimate that is dependent on interpolation may not be able to ‘follow’ the dynamic change in the channel of interest. In many cases, such changes can take place in both frequency and time, and in only ‘localized’ areas of the time-frequency map of the channel space.

Another problem associated with the prior art is that often, the ‘quality’ of the channel is not uniform across the time-frequency space of interest. For example, for signals that comply with the ECMA-368 UWB specification, there can be multiple places in time and frequency where the channel may experience drastically increased interference due to presence of narrowband interferers, both man-made and natural, and resulting degradation. The signal-to-noise ratio of such channel sub-spaces can be much lower than in the rest of the channel space. As is well-known in communication systems theory, if one distributes the information-carrying symbols uniformly across such channels with irregular qualities across its space, one can only obtain sub-optimal performance in demodulation.

The prior art approaches to these problems are generally concerned with suppressing unwanted signals, correcting the signal characteristics of the signals, and making the mostly likely choice as to the transmitted data. Such approaches tend to fall into three basic categories:

1) procedures that use completely known signals, such as preambles and pilots, to extract channel characteristics and to perform equalization;

2) procedures that use signals that are only partially known, such as the data part of a packet, about which certain statistical knowledge is assumed but “exact” knowledge of the values of the signals are not known; and

3) procedures that combine the aforementioned two approaches. The first category of procedures are typically based on training, since the ‘known’ signals play the part of ‘training signals’. The second category of procedures is broadly defined as “blind signal separation” procedures. The third category of procedures could be referred to as “hybrid” procedures.

The use of preambles or pilots is a frequently used procedure in applying corrective processing to receive signals for better demodulation. Since pilot symbols occur in known times and places in transmissions and also are known in the pre-transmission signal, or pre-distortion values, the receiver can compare what is received to what is known to have been transmitted. The receiver then applies corrective techniques to the data during their reception. The basic assumption in using such training signals for channel estimation and equalization is that the channel in which the preambles or the pilots are dispersed has a sufficiently long coherence in either time or frequency, such that the dispersal of the preambles or pilots would enable accurate estimation of the channel based on interpolation.

In blind signal demodulation techniques, exactly known signals are not required. Instead, much less knowledge of the signals' general characterization, such as certain statistical properties, is required. The term “blind” refers to the signals that are separated without use of some information required by known techniques. Since no exact signal is known, the effects of the channel cannot be directly determined. Blind signal separation techniques tackle this lack of information by exploiting other statistical knowledge, such as the high-order moments of the signals. By maximizing a cost function due to each signal, a separation matrix may be obtained which will extract each signal from the mixture. By way of example, a blind signal separation technique was recently developed by the ICA.

Blind signal separation procedures are typically computationally intensive, due to the often required iterative steps of computation intensive matrix manipulations. Procedures that combine the use of blind and training-based channel estimates are taught by the prior art. When these procedures are implemented, the training-based estimates of channels provide an initial seed to the iterative demodulation steps used for blind separation of signals in the data part. Furthermore, in these procedures, results close to those by linear minimum squared error estimate (LMSEE) training-based approaches are obtained, even though the required computation is often much less intensive than for such purely blind methods such as the ICA. Again, such results demonstrate that when and if training data, such as pilots or preambles, is available, and the coherence of the channel is adequate, then a combination of the blind and non-blind procedures may be utilized.

Other approaches found in the prior art addresses the requirement for more than one pilot. However, for proper operation, the channel coherence time has to be sufficiently long. FIG. 4 is a representation of one the implementations of this method. Demodulation processing takes place on a continuous basis by alternating exploitation of both pilots (training sequences) and unknown data. The computational load is mitigated because the results from one form of processing are used to seed the processing stage for the other form of processing.

Some reduction in computation for at least one type of modulation scheme was reported in the prior art. Essentially, the reduction can be explained by the seeding of results from the previous processing steps giving the next processing step a better initial solution, which facilitates faster convergence to a good solution.

When obtaining a discrete solution per processing block, each segment's results only provide seeds to the next stage. However, temporal and spectral variation in coherence often exists, so that a block processing independent of the neighboring blocks would yield sub-optimal results. In order to address this problem, the prior art provides continuous seeding to the neighboring processing blocks, as well as intra-block sub-block data using sliding window techniques.

One way to deal with some of the problems described above is to use error correction coding on the control and data symbols in the transmitter. When channel conditions deteriorate locally and result in errors in symbol detection at the receiver, the presence of redundant, distributed information about the original signal in the transmitted waveform allows the receiver to recovering the original symbols by using decoding techniques.

Another way traditional procedures are used to alleviate the above-mentioned problems is to allocate a significant portion of time-frequency resources of the transmitted waveform to the known, training signal, so that, even when impairments take place for a subset of the training symbols, the rest of the training symbols may be sufficient to be useful in recovering channel information and assisting the demodulation of the data symbols. Typically in OFDM systems, training signals, comprised of preambles and pilots, can take up 10% or more of the time-frequency resources. However, this method can typically result in over allocation of training signal, since the design of the system would typically have to be performed for the worst-case provisioning of the training symbols. The result of such over allocation would be under utilization of the true capacity of the channel, for the transmission of the actual, information-carrying data symbols.

The disadvantages of the prior art in continuous channel estimation and signal extraction in UWB OFDM systems is that it is not clear how to vary the sliding-window sizes and the displacements and directions of the seeding, and it has not been considered what to do with sliding windows in the presence of detectable interference or tainted symbols.

As to the sliding window method, the prior art does not fully consider how the sliding window's sizes vary over the successive interactions, depending on the channel quality on the various ‘regions’ of the time-frequency plane. The need to have varying-sized time-frequency windows is related to the fact that different regions of different sizes in the time-frequency channel can have different characteristics in terms of quality and temporal and spectral variations. Thus, prior art procedures that rely on ‘fixed regions’ of time-frequency blocks for seeding or interpolation based continuous channel estimation may not work very well if part of the time-frequency channel experiences interferences as set forth above. The channels also may experience time-dependent and/or frequency-dependent variation over periods of time duration that is relevant to the receiver. Furthermore, the prior art is not clear as to how to determine the ‘sizes’ of the seeding windows. Although a suggestion that the sizes to be determined according to variance considerations is found in the prior art, little detail is given.

The prior art is not clear as to how the displacements and directions of the seeding should be varied. The existing methods also have not fully considered how best to determine and even vary, if appropriate, the displacements and directions of the successive seeding of the sliding windows in the UWB OFDM time-frequency channel planes.

Moreover, the prior art does not consider what to do with sliding windows in the presence of detectable interference or tainted symbols. Because of their very wide bandwidths and also due to the fact that these devices are capable of roaming due to their small form-factors and usage models, the UWB devices can easily face narrower-band interferences, both man-made and natural, that may vary in time and frequency. Since the expected new, higher-rate update to the existing ECMA-368 UWB system, for example, is expected to allow even wider bandwidths than the current standard, for instance using a full time-frequency interleaving (TFI) of multiple 528 MHz sub-bands within the 7.5 GHz allowed band between 3.1 GHz and 10.6 GHz, and also since there are bands such as the 5 GHz unlicensed national information infrastructure (UNII) bands that are unregulated and already have commercial transceiver products, such as the 5 GHz IEEE 802.11a devices or the IEEE 802.16 devices, it is very feasible that the UWB systems, especially the future higher-bandwidth UWB systems, may be subject to potential narrower-band sources of interference while in operation.

Adding to this difficulty is the possibility of overlaps in UWB pico-nets and/or scatter nets. Suppose that two physically close pico-nets use different but overlapping spectral bands. For example, the first pico-net uses the full 7.5 GHz UWB bandwidth, while the other uses only one 528 MHz frequency block using fixed frequency interleaving (FFI). Both pico-nets then would be subjected to significant mutual interference over large portions of their operation channels.

### SUMMARY

The invention relates to an OFDM receiver configured to process received radio frequency (RF) signals to correct for propagation induced distortions and ultimately extract the individual desired signal streams. The invention improves channel correction techniques for OFDM systems so that higher effective data rates can be achieved with a minimal processing load. OFDM channel values determined due to known sequences in one domain can be used to seed solution matrices from channel value determination in other domains. This method can be applied to MIMO systems in order to deal with signal distortion while maintaining a reasonable processor loading profile.

In one embodiment of the invention, channel estimation is optimized in a UWB wireless communication system. The OFDM signal is mapped onto a time-frequency graph. The signal is then divided into overlapping windows. After checking the signal for tainted symbols, the windows are merged. As each window is estimated, the value of the estimation is used to seed the computation for the next window, thus improving channel estimation processes.

### BRIEF DESCRIPTION OF THE DRAWINGS

The foregoing summary, as well as the following detailed description of the invention will be better understood when read with reference to the appended drawings, wherein:

FIG. 1 shows an example of carriers transmitted orthogonally;

FIG. 2 shows an example of carriers received with offset errors;

FIG. 3 is a map of pilot distribution in a UWB signal;

FIG. 4 shows an example of continuous signal processing exploiting pilots and data used for blind channel estimation;

FIG. 5 shows an example of continuous signal processing loading;

FIGS. 6A and 6B show an example of pilot interpolated values;

FIG. 7 shows an ECMA-368 frame structure;

FIG. 8 shows representative portion of channels proposed in ECMA-368;

FIG. 9 shows a simplified ECMA-368 frame structure;

FIG. 10 shows examples of visual nomenclatures for seeding operations;

FIG. 11 shows examples of preamble pilots used to seed a data matrix;

FIG. 12 shows an example of matrix usage by sliding time window technique;

FIG. 13 shows an example of matrix usage by sliding frequency window technique;

FIG. 14 shows an example of mixed time and frequency sliding windows;

FIG. 15 is a representation of initial partitioning of a UWB signal using atomic windows of the invention;

FIG. 16 is a representation of multiple sliding windows of different shapes and sizes according to the invention;

FIG. 17 is another representation of multiple rectangular sliding windows of different sizes according to the invention;

FIG. 18 is another representation of multiple sliding windows having same lengths according to the invention;

FIG. 19 is a representation of a seeding sequence for sliding windows;

FIG. 20 is a representation of a periodic tiling of the time-frequency plane for tiling and sliding-direction determination of the sliding windows;

FIG. 21 is representation of sliding windows with tainted symbols;

FIG. 22 is a representation of sliding windows with tainted symbols removed;

FIG. 23 is a representation of sliding windows with a break in seeding for windows having tainted symbols; and

FIG. 24A is an example of a block diagram of an OFDM receiver in which the invention is implemented;

FIG. 24B is an example of a block diagram of a two-dimensional processing unit used in the receiver of FIG. 24A; and

FIG. 25 is a flow diagram of a method implemented by the OFDM receiver of FIG. 24A.

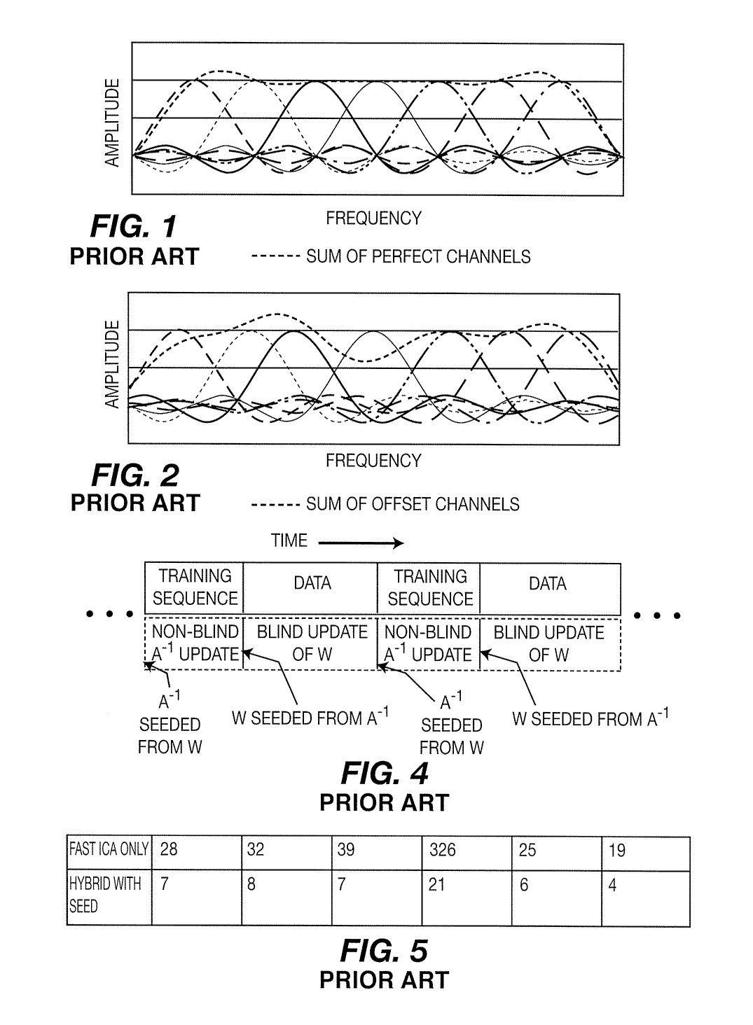

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

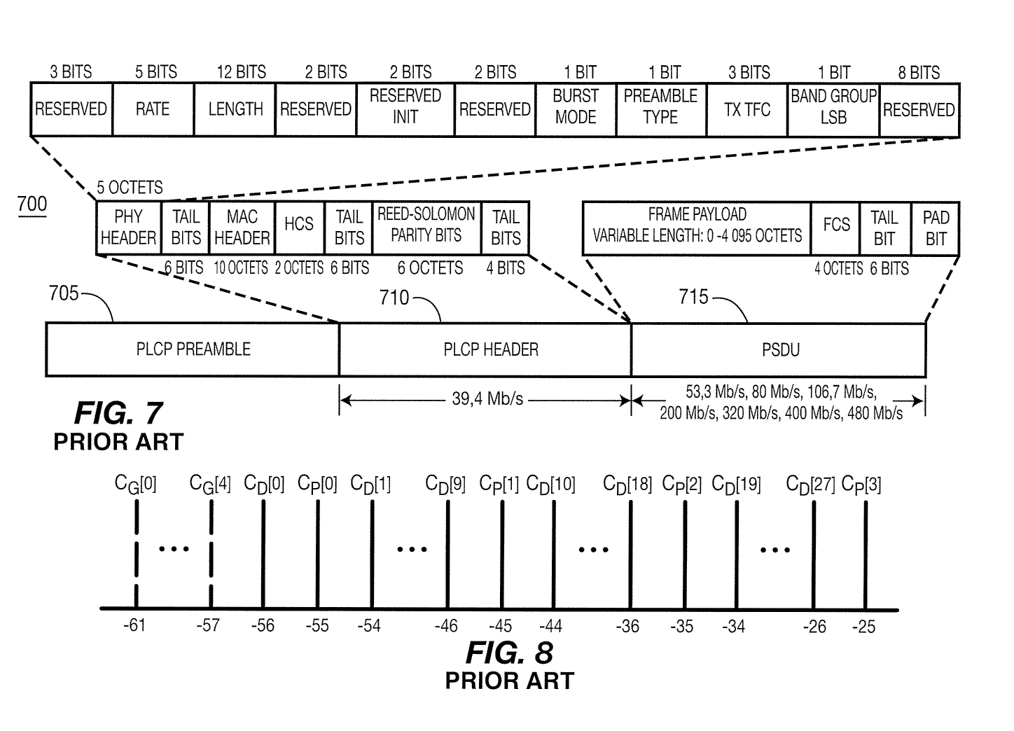

FIG. 7 shows an example of a physical-layer frame structure 700 of an ECMA-368 UWB OFDM system. The ECMA-368 frame consists of a physical-layer convergence protocol (PLCP) preamble 705, a PLCP header 710, and a PSDU 715. FIG. 7 is not to scale, and, for illustrative purposes, the PLCP Preamble and Header parts are exaggerated.

For the purpose of illustration, the general structure of the ECMA-368 standard is presented. It will be recognized that this is just one implementation, and the invention to be described can be extended to other implementations with a change in values of certain parameters while still falling under the scope of this disclosure.

The frame structure 700 is shown in FIG. 7. Note that the PLCP Preamble and Header are not drawn to scale with the PSDU, which contains a variable length frame payload. The PLCP preamble 705 and the PLCP header 710 may be used as training sequences.

FIG. 8 shows the channel allocation for ECMA-368 standard, whereby the allocation of data (C_{D}) and pilot (C_{P}) symbols is shown, rather than the overall numbering plan. The C_{G} channels shown in FIG. 8 are guard bands to other channel bands and will not be further discussed.

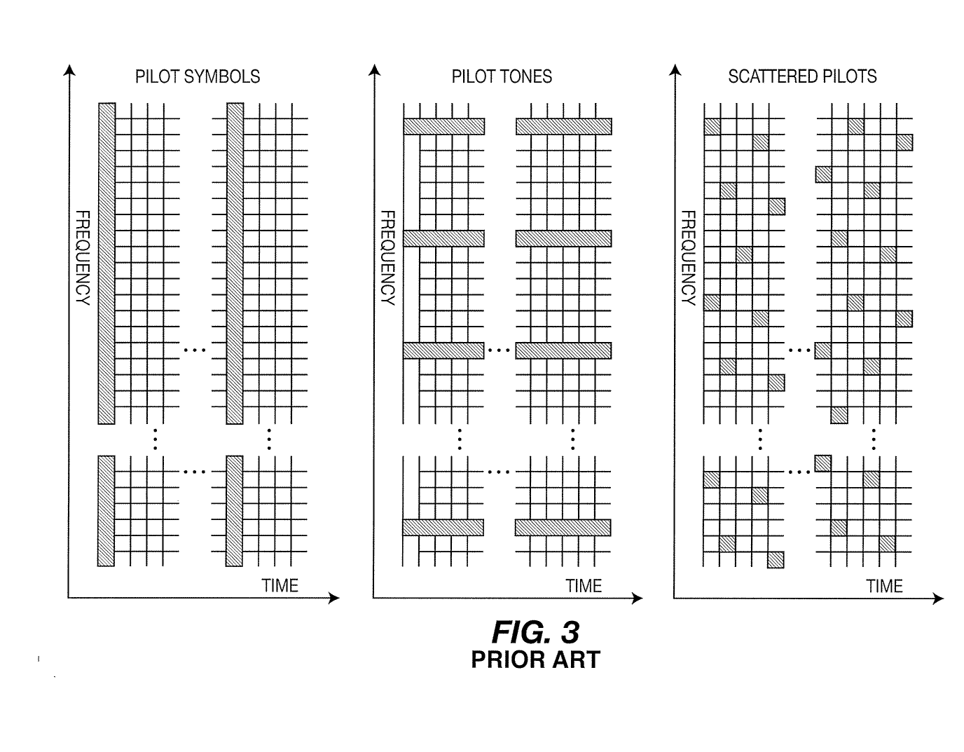

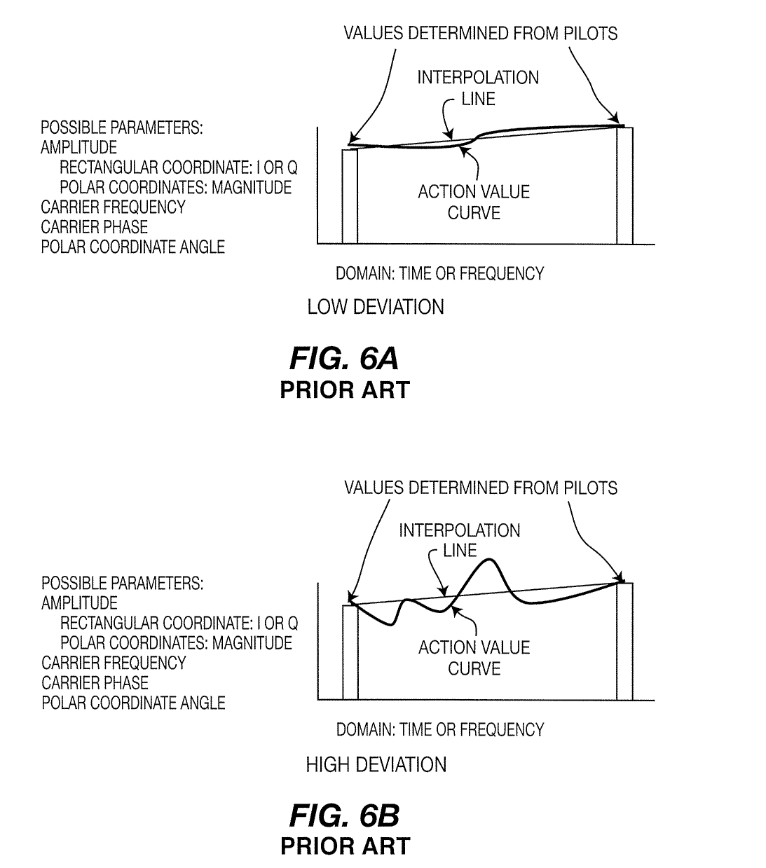

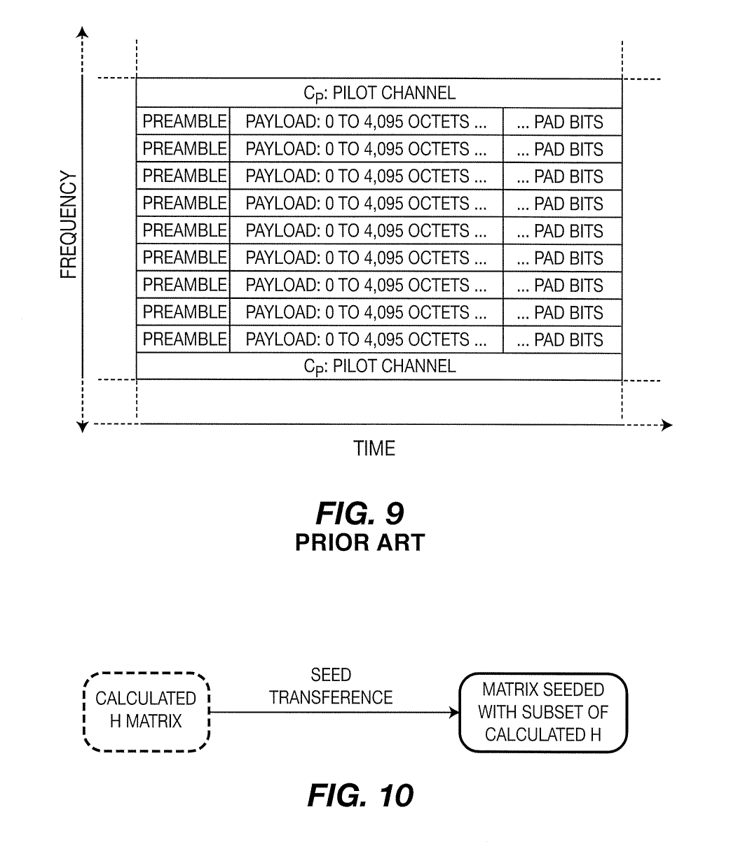

FIG. 9 shows a simplified ECMA-368 frame structure, which is a variation on the pilot allocation means expressed in prior art FIG. 3, and is based on functions necessary to the invention as shown in FIGS. 7 and 8. FIG. 9 does not show specific counts of symbols or time periods, since these can vary per parameters, such as those in Table 1, and other parameters that may be found in the standard. An example is the streaming and burst modes which have different preamble symbol lengths. While FIG. 9 shows continuous time and frequency occupancy, this is an extreme packing case and may not actually occur during any given transmission sequence.

The basic constituents of FIG. 9 are shown as one frame flanked by frames before and after it in the horizontal time dimension. In FIG. 9, pilot channels flank nine data channels in the vertical frequency dimension. The pattern is repeated as shown in both directions until one reaches the guard bands at the end of the frequency band. Pilots are continuously available in the pilot channels or periodically available in the data channels as part of the preambles. The subsequent frame preamble, if it exists and is known to the decoder could be used for predecessor data processing purposes.

The boundary between the payload and pad bits is variable depending on the actual size of the payload. The payload data therefore is varying in its average distance from the always present preamble for the frame, and the potential preamble from the next frame.

The channel usage is of the fixed frequency interleaving (FFI) type since the data is shown remaining on one channel. It could also be of the time frequency interleave (TFI) type which has the data sequentially move symbol by symbol among three adjacent data channels. The processing of the invention is performed at the physical level, and the logical interleaving type utilized only has effects as it pertains to the occupancy of the channels.

The following description makes specific reference to channel matrices since they involve the type of distortion most often addressed in work of this nature. The techniques however are applicable to a wider set of parameters in general, (e.g., frequency determination errors).

Also, a particular technique may be referenced for determination or usage of the matrix components for illustrative purposes. The actual potential usage however is inclusive of a wider set of exploiters of the techniques, (e.g., ICA may be described, but it may be useable with minimum mean-squared error (MMSE)).

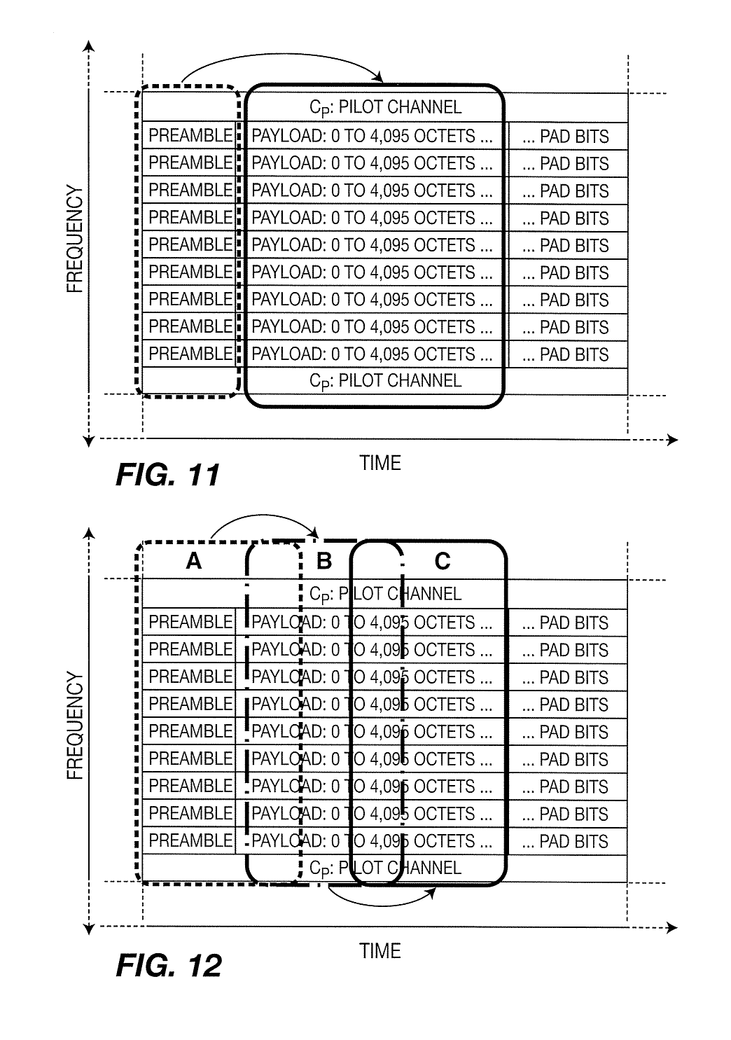

One approach to improving channel processing is to perform traditional processing of the training sequences of the preamble, use the results to seed the blind processing during the payload, and if a subsequent frame use of the channel exists use the blind processing results to seed the subsequent frame preamble. FIG. 10 illustrates the visual nomenclature that will be used in the following discussions. This nomenclature is used in FIG. 11 to show that matrix values determined during the Preamble are used to seed determination of the matrix during the data. Processing during the data periods can be superior to interpolation techniques because it operates on the actual data, and therefore is less likely to incorrectly determine the corrective factors in highly nonlinear channel circumstances.

Seeding may also be from the data periods into the pilot periods. If the fluctuations in the channels is significantly fast and severe during the time period of the data frame, the sliding window approach of FIG. 12 is preferably used. The time width of data enclosed by rectangle A is chosen to be small enough for an acceptable degree of time correlation in regards to the channel values. The channel values determined during A are then used to seed the matrix covering the data in B. The values in B are then used to seed C. The number of processed blocks used will vary depending on time coherence, processor loading, and necessary robustness of the result.

The degree of overlap of the processed groups is mostly determined by statistical constraints. To allow the solutions to be minimally affected by noise requires a sufficiently large data set to average to insignificance compared to the data signal levels.

The processing blocks could include the pad bits when their use as pilots or need to satisfy statistical constraints is beneficial. Note that while it seems natural to have the seeding progress in order with time, the order could actually be changed to occur in any sequence. The main rationale for following the order in FIG. 12 is to start with training sequences, and proceed with adjacent groups for the most robust determination of values. The same rationale would work if the pad bits were treated as training sequences and the prior group in time was seeded from it. One could even work from the earliest time (A) and latest times (C) simultaneously and use them both to seed the middle times (B).

The three groups in FIG. 12 are shown for illustration purposes, and the actual number of groups can be chosen dependent on the prevailing conditions and requirements.

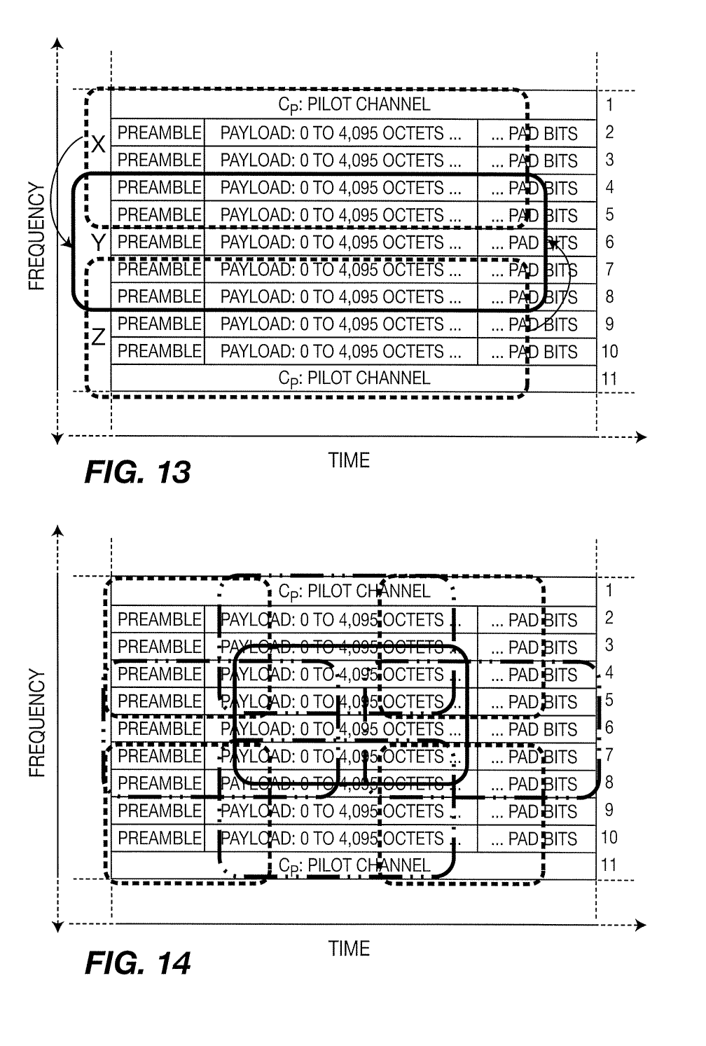

Severe fluctuations in the frequency dimension can be handled in a similar sliding window as shown in FIG. 13. As shown, Xε{1,2,3,4,5}, Yε{4,5,6,7,8}, Zε{8,9,10,11}, the values determined for channels 2, 3, 6, 9 and 10 from the sole group they belong to are utilized in the actual data processing. There are several options for channels 4, 5, 7, and 8 since they are included in two groups. One approach is to choose the solution group for which they are most deeply embedded: 4→X, {5,7}→Y, 8→Z. Another approach is to use the weighted average from both groups, with the higher weight being for the deeper embedded group.

The order of determination preferably starts with inclusion of the pilot channels and progresses to the groupings with a least amount of training supported as shown by the arrows connecting the channel groups in FIG. 13. The three groups in FIG. 13 are for illustration purposes, and the actual number of groups can be chosen dependent on the prevailing conditions and requirements.

FIG. 14 depicts a general embodiment of the invention. In FIG. 14, there are a total of 9 fixed-size sliding windows, where each window overlaps somewhat with its neighboring windows. The overlapping windows are used to seed the neighboring windows in a sequence in the time-frequency channel plane. Within the sequence, the solution obtained in a prior window seeds the processing in a next window. A backward and forward alternation of the results for iterative seeding is possible.

The advantage of such continuous, sliding window based seeding is that proper seeding can greatly reduce the number of iterations to the solution of the matrix. Furthermore, proper seeding can keep the solution from inadvertently getting stuck in a local minimum not coinciding with the optimum solution.

The benefits from seeding in the cases discussed are two-fold: (1) proper seeding can greatly reduce the number of iterations to the solution of the matrix, and (2) proper seeding can keep the solution from inadvertently getting stuck in a local minimum not coinciding with the optimum solution.

Pad bits may be treated as training sequences, since they follow a regular and known formation approach. The payload and pad bit boundaries need not be the same for any of the channels between two pilot channels. They may be treated as additional pilot channels when occurring time wise parallel to channels carrying data. Alternatively, the blind processing can ignore the fact that the pad bits are known and use them as constituents of the mixing matrix being processed.

Equation (1) shows a general representation for the matrices of interest.

$$x = [ \begin{matrix}{H}_{P 1 , 1} & {H}_{P 1 , 2} & … & {H}_{P 1 , 10} & {H}_{P 1 , 11} \\ {H}_{D 2 , 1} & {H}_{D 2 , 2} & … & {H}_{P 2 , 10} & {H}_{P 2 , 11} \\ ⋮ & ⋮ & ⋰ & ⋮ & ⋮ \\ {H}_{D 10 , 1} & {H}_{D 10 , 2} & … & {H}_{P 10 , 10} & {H}_{P 10 , 11} \\ {H}_{D 11 , 1} & {H}_{D 11 , 2} & … & {H}_{P 11 , 10} & {H}_{P 11 , 11}\end{matrix} ] [ \begin{matrix}{C}_{P 1} \\ {C}_{D 2} \\ ⋮ \\ {C}_{D 10} \\ {C}_{P 11}\end{matrix} ] + n \qquad Equation ( 1 )$$

### Where:

x: receive signal vector for all channels

n: noise vector

H_{Pj,k}: channel response for the pilot channel j,k both in magnitude and frequency

H_{Dj,k}: channel response for the data channel j,k both in magnitude and frequency

C_{Pk}: pilot channel data

C_{Dk}: data channel data

The subscripts P and D for the pilot and data channels respectively are mathematically unnecessary descriptors added to clarify the function of the particular channels. Since H_{j,k} and Hₖⱼ cover different frequency bands, reciprocity need not hold and their values are not necessarily equal.

If the orthogonal relationship of the transmitted data is retained at the receiver, Equation (1) merely collapses to a diagonal matrix as in Equation (2) and each individual channel of the receive vector x can be directly passed on for decoding. Making this assumption, one is able to use blind signal processing to separate MIMO channels due to the multiple receive antennas.

$$x = [ \begin{matrix}{H}_{P 1 , 1} & 0 & … & 0 & 0 \\ 0 & {H}_{D 2 , 2} & ⋰ & ⋰ & 0 \\ ⋮ & ⋰ & ⋰ & ⋰ & ⋮ \\ 0 & ⋰ & ⋰ & {H}_{D 10 , 10} & 0 \\ 0 & 0 & … & 0 & {H}_{P 11 , 11}\end{matrix} ] [ \begin{matrix}{C}_{P 1} \\ {C}_{D 2} \\ ⋮ \\ {C}_{D 10} \\ {C}_{P 11}\end{matrix} ] + n \qquad Equation ( 2 )$$

Equation (2) is not always a realistic situation and channels that are a certain frequency distance away from any given channel may cause significant distortion in said data channels. For instance, assuming only the adjacent channels are significant, the H matrix would be tri-diagonal. If further away channels are also significant, they add non-zero diagonals to the matrix, with the general case having a semiband width of s, where s=1+2*abs(j−k) and H_{j,k}=0 for the closest values of j and k. It is well known that such matrices are much simpler to solve, with an associated reduction in processor loading (e.g. O(7n) as opposed to full matrix O(ⁿ^{³}/₃) arithmetic operations.

$$\begin{matrix}x = [ \begin{matrix}{H}_{P 1 , 1} & {H}_{P 1 , 2} & 0 & … & 0 & 0 & 0 \\ {H}_{D 2 , 1} & {H}_{D 2 , 2} & {H}_{D 2 , 3} & ⋰ & 0 & 0 & 0 \\ 0 & {H}_{D 3 , 2} & {H}_{D 3 , 3} & ⋰ & 0 & 0 & 0 \\ ⋮ & ⋰ & ⋰ & ⋰ & ⋰ & ⋰ & ⋮ \\ 0 & 0 & 0 & ⋰ & {H}_{D 9 , 9} & {H}_{D 9 , 10} & 0 \\ 0 & 0 & 0 & ⋰ & {H}_{D 10 , 9} & {H}_{D 10 , 10} & {H}_{D 10 , 11} \\ 0 & 0 & 0 & … & 0 & {H}_{P 11 , 10} & {H}_{P 11 , 11}\end{matrix} ] \\ [ \begin{matrix}{C}_{P 1} \\ {C}_{D 2} \\ ⋮ \\ {C}_{D 10} \\ {C}_{P 11}\end{matrix} ] + n\end{matrix} \qquad Equation ( 3 )$$

In its simplest implementations, the processing during the data periods treats all entries as equal and iterate to a general cost function. For instance, MMSE drives the answer towards overall minimum error estimation. ICA attempts to maximize a measure of signal separation such as Kurtosis. However, this embodiment recognizes that there are pilot channels, embedded pilots and other sequences that are of a known form, frequency band, and time instance which could function as training opportunities. The cost function for which ever means is used to process the aggregate signal will therefore take these instances into account and minimize the differences from these values, while determining the other values under less stringent constraints. The result of including these training opportunities and biasing the processing results as indicated will be to obtain the most beneficial processing of the signals for final data decoding.

According to one embodiment of the invention, OFDM channel values determined due to known sequences in the time domain (e.g., pilots, padding) are used to seed solutions matrices for channel value determination during data periods. OFDM channel values determined during data periods are used to seed solution matrices for channel determination during known sequences. OFDM channel values determined due to known sequences in the frequency domain, (e.g., pilot channels, known sequences in data channels (e.g., padding bits)), are used to seed solutions matrices for channel value determination during data periods.

The size of the groups in the time and frequency dimensions may be adjusted to deal with the coherence values in each dimension. The overlaps of the groups may be adjusted as appropriate for conditions and goals tied to the applications in use.

Various techniques can be used to increase the rank of the received signal mixing matrix during either or both the known value periods and the data periods to allow more robust extraction or separation of the signals of interest. Use of these techniques will modify the seeding of the two prior claims in that they are no longer strictly the same dimensions. Antenna arrays may be used, including arrays with active or passive multiple elements, deformation of the antenna patterns, deflection of the antenna patterns and arrays that use correlated and uncorrelated data. Various different types of signaling may be used, including I&Q splitting, coding, over sampling.

The processing during data periods includes pilot channels and or embedded pilots or sequences that may be used as pilots. The cost function used for the processing minimizes the difference between these known sequences and the received signal streams, as well as the data itself.

The use of the preceding means to process the signals in combinations such that the signals may be robustly decoded within the power and processing constraints of the receiver and needs of the applications in progress.

In accordance with another embodiment, the invention uses the following two principles to determine the optimum sizes of sliding windows for seeding and other processing such as interpolation:

1) the entire time-frequency plane is initially partitioned into overlapped or non-overlapped consecution of many small, atomic windows; and

2) adjacent atomic windows are then merged to form eventual individual sliding windows, with objectives that:
a) each sliding window will have values of certain ‘channel measure’ criterion that fall within a pre-determined range; and
b) each sliding window will also have certain levels of overlapping with adjacent sliding windows.

The above principles allow, through merging, windows of different shapes than just rectangles. Allowing non-rectangular windows may have advantages in performance, but may suffer from relatively inefficient computation, due to dearth of computationally efficient algorithms for non-rectangular, or non-matrix data processing.

In one embodiment of the invention, the size S_{ATOMIC} of the initial ‘atomic’ sliding window is determined, with an objective of using a much smaller S_{ATOMIC} than the size (or area) S_{FRAME} of the time-frequency plane for the current frame. Since the atomic windows are allowed to overlap, the sum size S_{SUM} of all of the atomic windows is generally greater than or equal to the frame size S_{FRAME}.

Calling the ratio R_{INI}=S_{SUM}/S_{FRAME} and assuming this ratio is a system-specified parameter that the partitioning algorithm is given, the number N_{ATOMIC} of all of the atomic windows can be approximately determined as:

$${N}_{ATOMIC} \approx floor ( \frac{{R}_{INI} \times {S}_{FRAME}}{{S}_{ATOMIC}} ) \qquad Equation ( 4 )$$

where floor( ) is the integer flooring operator. The exact calculation requires the time-lengths and frequency-widths of the atomic windows and the frame space, as well as the lengths of the overlaps in both time and frequency dimensions.

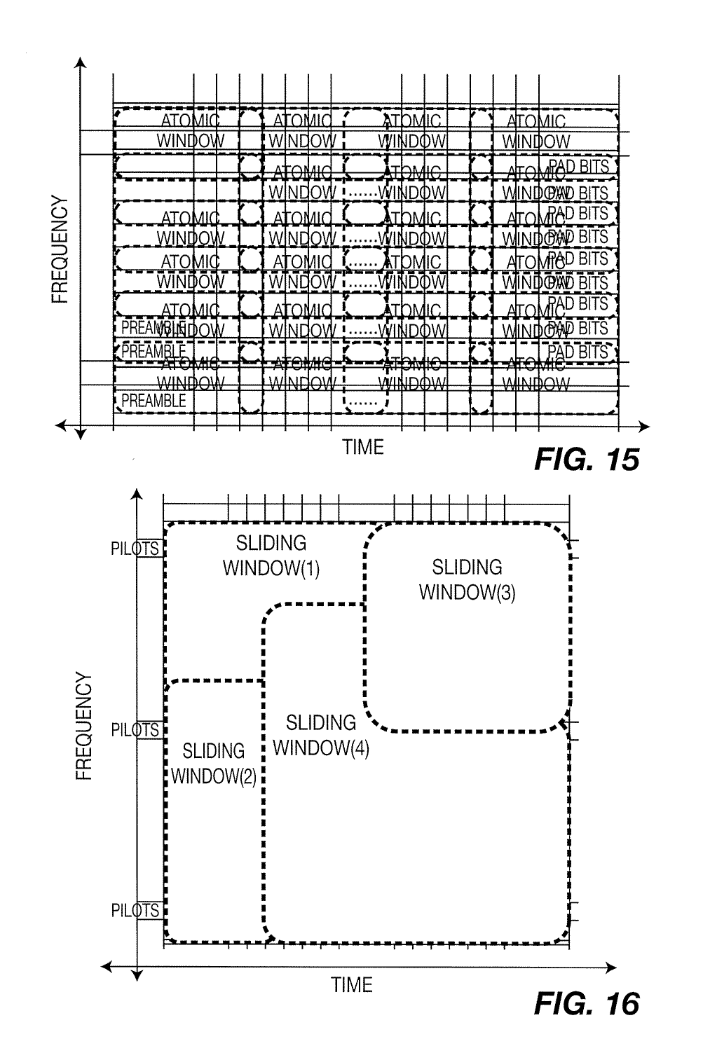

FIG. 15 depicts an initial partitioning of the entire channel's time-frequency plane into the ‘atomic windows’. Note that in this example the atomic windows are allowed to overlap on adjacency. In another embodiment, one may choose the atomic windows to not overlap. However, after merging of atomic windows, the final sliding windows may still be allowed to overlap.

The shapes of the atomic windows can be flexibly determined. One example is to have the atomic windows to have the same or similar aspect ratios in terms of time and frequency as the entire time-frequency channel for a single frame. In the case of ECM-368 systems, for example, the time-frequency channel space for a single frame-full of data is given by the following time and frequency dimensions:

$${T}_{FRAME} = 6 \times ceil ( \frac{8 \times LENGTH + 38}{{N}_{IBP 6 S}} ) \times 312.5 µ sec , \qquad Equation ( 5 )$$

where:

F_{FRAME}=528 MHz, LENGTH=0 . . . 4095;

N_{IPBP65}ε{100,150,200,300,375,600,750,900} are physical layer (PHY) parameters from the ECMA standard; and

ceil(x) is the smallest integer equal to or greater than x.

After the entire channel space is partitioned into N_{ATOMIC} possibly overlapping atomic windows, the merging process can begin by computing, from a chosen, for example the first in time and lowest in frequency, atomic window in a sequence, a measure of the channel's characteristic. Choice of such a measure could include channel strength, as measured in total energy within the particular atomic window, and/or channel variance, as measured by either total variance of the channel magnitude within the atomic window, or, total variance of the channel in a more local, for example high-frequency region in a 2-D FFT of the time-frequency channel response, or combinations thereof.

Assume, for example, that the merging criterion is chosen to be the total channel variance, and that the total channel variance in the entire frame's channel space of size S_{FRAME} is of value V_{FRAME}. Assume also that the maximum number of eventual partitions of sliding windows is pre-specified or determined along computation loading constraints to be N_{WINDOWS}. Suppose that one wishes to partition the entire frame's channel space into N_{WINDOWS} sliding windows each of which will have target value V_{TARGET} for its own total channel variance measure V_{WINDOW} equal to or approximately equal to V_{FRAME} divided by N_{WINDOWS}, i.e.,

$${V}_{TARGET} = \frac{{V}_{FRAME}}{{N}_{WINDOW}} \qquad Equation ( 6 )$$

Also, assume a sliding window will be considered acceptable if each, after construction by merging, has its total channel variance value V_{WINDOW} within a particular range, for example, 100% to 120%, of the target value V_{TARGET}. Starting from the first chosen atomic window, for example, W_{ATOMIC}(1,1), that is the atomic window placed first in the time and first in the frequency domains, add or merge, one by one, an adjoining atomic window to the sliding window until the sliding window's total channel variance value falls within the acceptable range of the targeted value. As for which adjacent atomic windows should be considered for possible merge to the sliding window, one could allow any atomic window that is adjacent to the sliding window under construction that is not yet part of the present window, and has the smallest incremental additive value of the V_{ATOMIC} measure among all atomic windows that adjoins the current sliding window under construction.

One can choose from many different options in the allowed ‘shape’ of the sliding windows. Seeding can take place even if all of the finally determined sliding windows have arbitrary shapes. FIG. 16 depicts selection of four sliding windows, where there was no constraint put on the shape of the sliding windows and as a result the final sliding windows all have free, non-rectangular shapes.

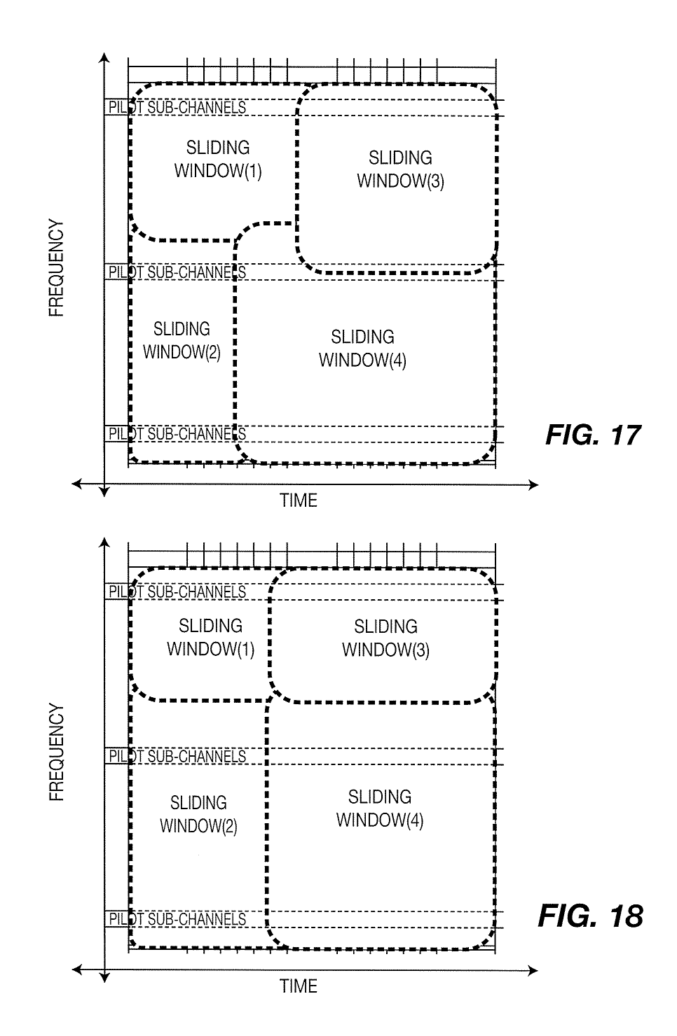

For computational efficiency of seeding and signal extraction, however, an obvious choice of the shape of the sliding windows is a rectangle, since these shapes often allows use of efficient matrix-based computations. FIG. 17 depicts selection of four sliding windows where each window is a rectangle but with different lengths (time occupancy) and widths (frequency bins). By further limiting the rectangular shapes of the sliding windows, one can obtain sliding windows that are not only rectangles but also ones where any adjoining pair of sliding windows would have the same lengths in at least one dimension, for example, the time or the frequency. FIG. 18 depicts such a case with four selected sliding windows wherein vertices of any adjoining pair of the sliding windows have the same length.

Suppose that, using the method of the invention, as set forth above, the UWB OFDM receiver partitions the time-frequency channel plane into N_{WINDOWS} overlapping sliding windows of general shapes. Note that each of the sliding windows is constructed by merging a number of atomic windows. Each sliding window in this selection is to be used for a sequential seeding of an initial solution to the channel/signal separation solutions in the next sliding window. It is left to determine a good sequence for the sliding windows for seeding.

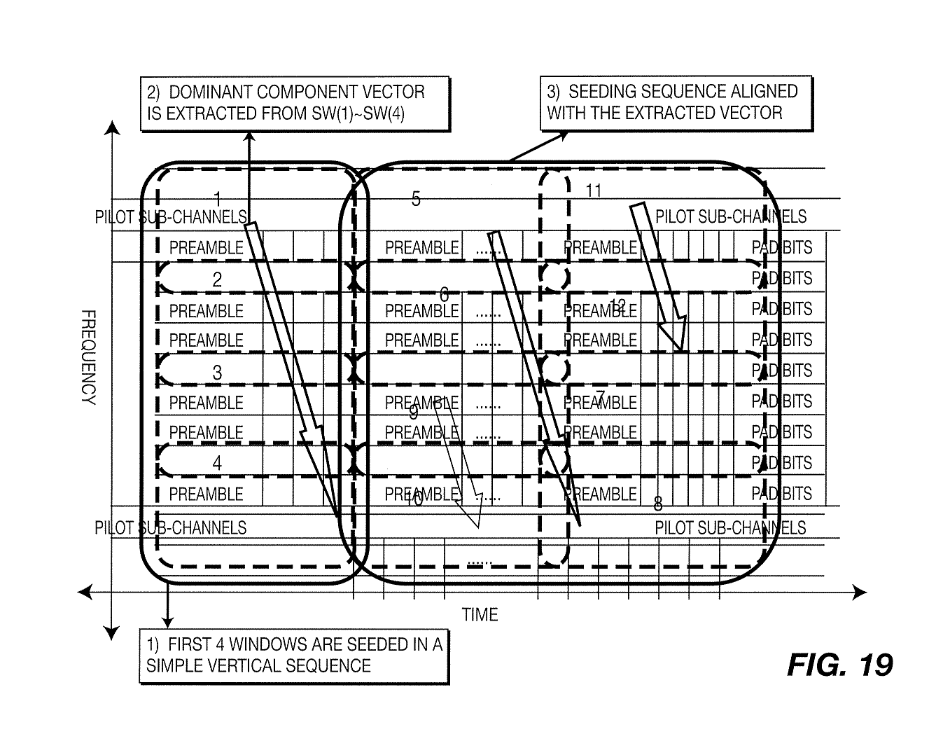

One sequence is constructed by counting the sliding windows that start with the earliest time and the lowest frequency, then proceeding to the sliding window that has similar time but higher than the first frequency bins, and so on, until all of the frequency bins are exhausted, and then proceeding to the sliding windows placed in later time slots, again starting from the lowest frequency bins and proceeding till the highest frequency bins. FIG. 19 depicts such a sequencing of sliding windows. The sliding window numbering in preceding figures FIGS. 16, 17 and 18 follow this sequencing.

In some cases, one may wish to use a more sophisticated sequencing. For example, time-frequency analysis, such as the Chirp-Z transform analysis, can be conducted on the preambles or even a few sliding windows with the earliest time. Dominant time-frequency component vectors are extracted, and the sliding windows are sequenced pursuant to a line that broadly follows the alignment of the extracted time-frequency component vectors. FIG. 19 depicts a case where first a dominant time-frequency component vector is extracted from an analysis of the first two rectangular sliding windows, and then seeding sequence for the remainder of the sliding windows is constructed by a collection of vectors that are broadly aligned, and replicating, the extracted time-frequency component vectors.

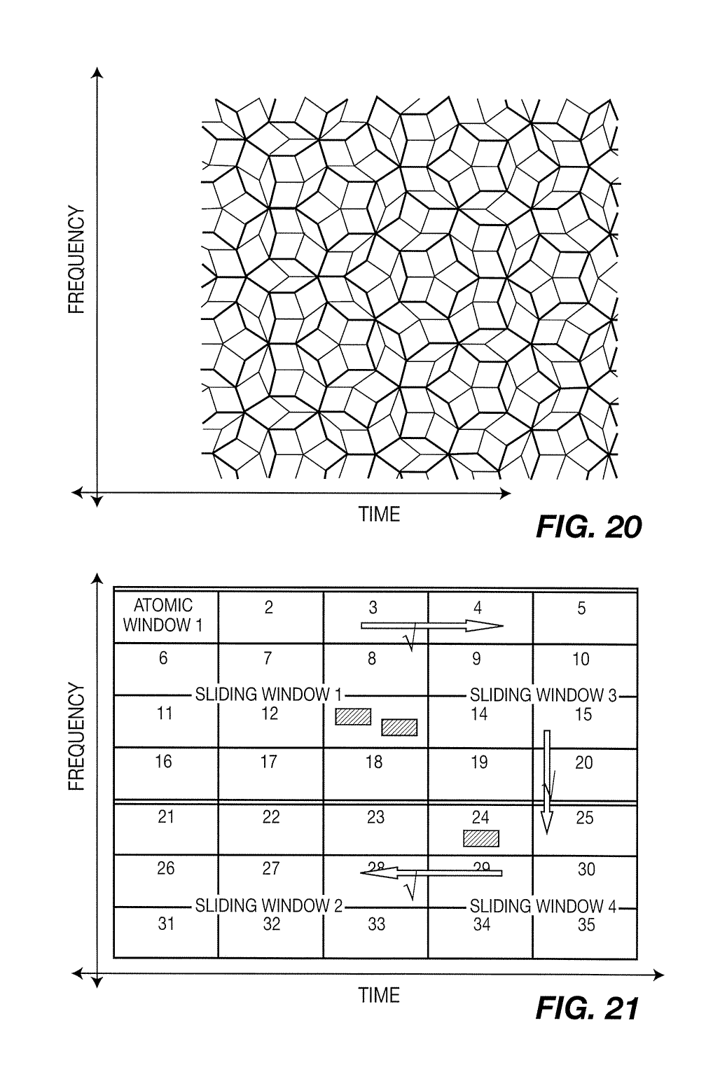

Another possible method of sequencing, applicable to cases where the sliding-window partitioning is performed using certain regular-sized non-rectangular polygons is to use a technique called aperiodic tiling. An aperiodic tiling or, equivalently, aperiodic tesselation, is a tiling of a plane by a set of prototiles that can only be tiled in a non-repeating, or aperiodic, pattern. A well known example of aperiodic tiling is the Penrose tiling, depicted in FIG. 20.

Aperiodic tiling exhibits interesting mathematical properties, the absence of any periodicity in any direction in the tiled plane being one. That property, in particular, may be useful in forming and sequencing of the sliding windows and seeding, because the aperiodicity of the tiling pattern may help to avoid introduction of channel estimation biases that may arise from seeding by use of more regular, periodic seeding sequences.

A UWB OFDM receiver can benefit and perform better if it can combat narrower-band interference and signal impairments within the channel it operates in. In the method of the invention, disclosed herein, such processing is performed on a unit processing area, one by one. The atomic windows, as set forth above, can be used again as a unit of processing. An alternative is to use a smaller, single time-frequency slot such as a unit consisting of one FFT bin and one symbol time. Once a unit processing area is decided, the receiver then can apply any of the various techniques to deal with detected interference or impairment. One method is to remove the channel information, which is likely to be tainted and unreliable if the particular unit area has been impaired with strong interference or other channel impairments, corresponding to the impacted unit processing area, from the overall calculation of channel estimates or signal-extraction matrix processing. In channel estimate calculation, for example, the information from the tainted unit processing area could be overlooked or treated as “don't care” conditions, and channel estimates corresponding to the overlooked unit processing area would be replaced by, for example, interpolation obtained by processing adjacent, valid, unit processing areas.

FIG. 21 depicts a case where an atomic window is treated as unit processing area. In FIG. 21, it is illustrated that a total of 35 atomic windows, arranged in 5 time-domain columns and 7 frequency-domain rows, occupy the whole frame of the time-frequency channel space. It is also depicted that three time-frequency symbols included in two non-joining atomic windows (windows 13 and 24) are tainted, or unreliable, as a result of channel impairment, for example, interference or time-varying noise. The three time-frequency symbols tainted are depicted as small squares marked with skewed-line patterns in the time-frequency channel space. Also, the two atomic windows that include the tainted time-frequency slots are marked with red hues in the figure. Detection of the tainted symbols can be made by various means, which are beyond the scope of this disclosure, are not treated here, but should be well-known in signal processing and communication demodulation disciplines.

FIG. 21 also depicts sliding windows for seedings that have been obtained following the methods set forth above. Four non-overlapping seeding windows are shown. Atomic window 13 contains two tainted symbols and is a part of the sliding window 1, and the atomic window 24 contains another tainted symbol and is a part of the sliding window 4. Using the methods set forth herein, it is determined that the order or sequence of seeding has been determined to be sliding windows 1-->3-->4-->2. This sequence is depicted by the block arrows and the check marks in FIG. 21.

A method used by the receiver to deal with the symbols that it determines or assesses as too tainted or unreliable by several methods is set forth herein.

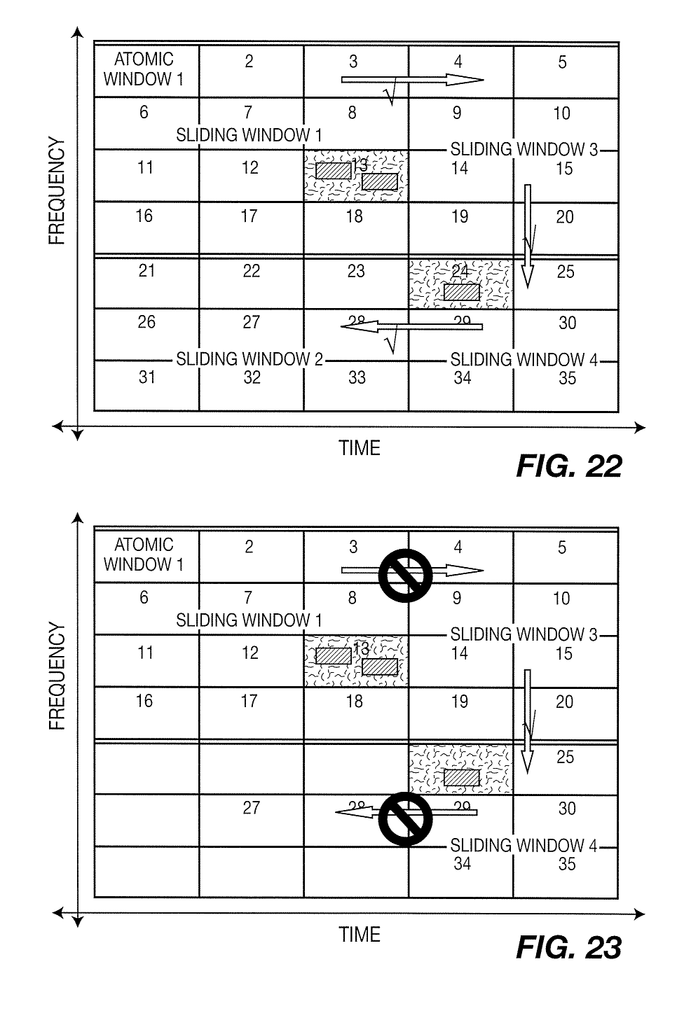

One possible method it that the receiver could remove the atomic windows that contain the tainted symbols from being included in forming the sliding windows. The resulting seeding sliding windows that result from the removal of the atomic windows would be used for seeding. This case is illustrated in FIG. 22. In FIG. 22, the two atomic windows 13 and 24 are removed in the forming stage of the sliding windows 1 and 4, respectively. Thus, the sliding windows 1 and 4 are no longer rectangular as was in the previous FIG. 21. The seeding sequence follows the original sequence of 1-->3-->4-->2, as depicted by the white arrows.

In another embodiment, when the whole or a significant portion of a sliding window is tainted, or equivalently, a significant fraction of the total atomic windows comprising of a particular sliding window is tainted and removed from signal-extraction or channel estimation processing, the receiver may choose not to allow channel or signal estimates from such a sliding window to seed to another sliding window's initial calculations, or to limit the degree by which the channel estimates from the tainted sliding window to be ‘included’ in the initial seed for the next window's channel estimates. In this case, the solutions for the sliding window next-in-line to the tainted sliding window may be obtained by randomly seeding the matrices rather than seeding them from the results of the previous, tainted sliding window.

Referring to FIG. 23, the sliding window 1, due to the presence of atomic window 13 that contains two severely tainted symbols within it, will not seed the next window in the seeding sequence, that is, the sliding window 3. Thus sliding window 3 will be seeded by a random matrix rather than the matrix obtained from sliding window 1. Sliding window 3, since it itself does not included tainted symbols, can still seed the sliding window 4. Sliding window 4, however, cannot seed sliding window 2, due to the presence of tainted symbols in one of its constituent atomic windows, and the latter has to be seeded by a random matrix. The breakage in the seeding sequence is depicted in FIG. 23. In FIG. 23, the white block arrows with the “stop” marks indicate breakage in seeding, and the check marks indicate seeding. The rectangular shapes of the sliding windows and are also depicted in FIG. 23.

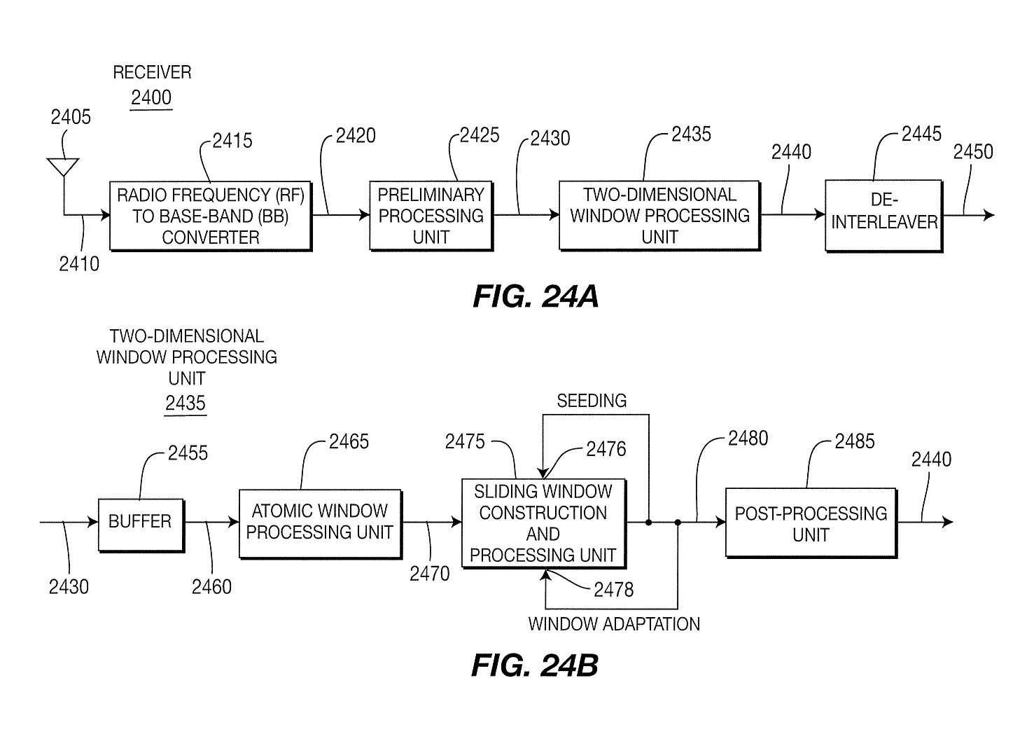

FIG. 24A is an example of a receiver 2400 in which the invention is implemented. The receiver 2400 may be incorporated into a WTRU and/or a base station. The receiver 2400 may include at least one antenna 2405, an RF to baseband (BB) converter 2415, a preliminary processing unit 2425, a two-dimensional window processing unit 2435 and a de-interleaver 2445.

Referring to FIG. 24A, the at least one receive antenna 2405 receives RF signals 2410 via a multipath radio channel, which are converted to BB signals 2420 by the RF to BB converter 2415. The BB signals 2420 include a time sequence of OFDM symbols, which have traveled through the multipath radio channel, causing time and frequency dispersion, and introducing noise and interference. The preliminary processing unit 2425 converts the sequence of corrupted OFDM symbols in the BB signals 2420 into the frequency domain by performing a fast Fourier transform (FFT) on each OFDM symbol in sequence after removing a guard time interval between adjacent OFDM symbols. The output 2430 of the preliminary processing unit 2425 consists of a sequence of corrupted complex valued sub-carrier amplitudes, which are buffered by the two-dimensional window processing unit 2435 in a 2-dimensional matrix, as depicted in FIG. 9, and then partitioned into a two-dimensional array of “atomic windows”, as depicted in FIG. 15. The output 2440 of the two-dimensional window processing unit 2435, which is a sequence of detected data bits, is then de-interleaved by the de-interleaver 2445 to provide a de-interleaved output 2450. The deinterleaving process, performed by the de-interleaver 2445 of the receiver 2400, corresponds to an interleaving process, which is typically performed at a transmitter, in order to introduce time diversity in the transmitted signal and thereby improve the robustness against channel errors that occur in bursts.

As shown in FIG. 24B, the two-dimensional window processing unit 2435 may include a buffer 2455, an atomic window processing unit 2465, a sliding window construction and processing unit 2475, and a post-processing unit 2485. The sequence of corrupted complex valued sub-carrier amplitudes on the output 2430 of the preliminary processing unit 2425 are buffered by the buffer 2455 in a 2-dimensional matrix, as depicted in FIG. 9. The output 2460 of the buffer 2455 is then partitioned by the atomic window processing unit 2465 into a two-dimensional array of “atomic windows”, as depicted in FIG. 15. The sliding window construction and processing unit 2475 groups together varying numbers of adjacent atomic windows provided by the atomic window processing unit 2465 via output 2470, thereby creating sliding windows, as illustrated in FIGS. 16-18. The time-frequency data, (i.e., time series of sub-carrier corrupted amplitudes), is processed by the sliding window construction and processing unit 2475 using one of several schemes, followed by a post-processing unit 2485, whose details depend upon the processing performed by the sliding window construction and processing unit 2475.

For example, if the sliding window construction and processing unit 2475 estimates the channel response in time and frequency domains, the post-processing unit 2485 performs subsequent equalization and detection of the sub-carrier modulated data, (i.e. mapping QAM symbols to binary data). Another possibility is for the sliding window construction and processing unit 2475 to perform blind interference suppression using ICA techniques, followed by channel estimation and data detection.

In any case, note that the sliding window construction and processing unit 2475 performs a multi-step process that is executed on the totality of the sliding windows, such that overlapping windows in the output 2480 seed the results of processing one sliding window into the adjacent one, via seeding input 2476. This of course is what produces efficient fast converging and robust estimation of channel, interference suppression, and the like.

It is also noted that the results of the sliding window provide information regarding the optimal way to group the atomic windows to construct the sliding windows. Accordingly, the output 2480 of the sliding window construction and processing unit 2475 is fed back via window adaptation input 2478, so that the sliding windows may be adaptively created to be optimally matched to the varying channel characteristics.

In the case where the receiver 2400 comprises multiple receive antennas 2405, the receive antennas 2405 may be used in a diversity mode or spatial multiplexing mode. In the former case, all receive antennas 2405 receive spatial variants of same transmitted signal, which are then combined optimally to exploit the spatial diversity. In the latter case of spatial multiplexing, each antenna 2405 receives multiple spatial data streams, which are separated via various MIMO schemes. In either case, the two-dimensional processing in time and frequency applies, as described in the single antenna case. It is also possible in this case that the sliding window processing be extended to three dimensions, namely time, frequency and space.

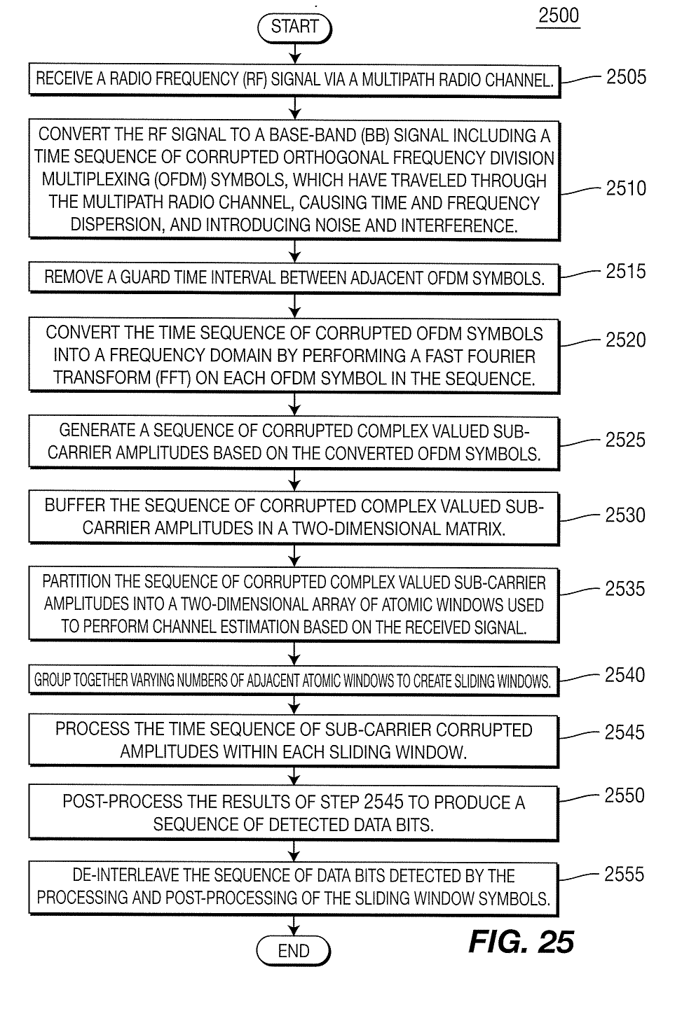

FIG. 25 is a flow diagram of a method 2500 implemented by the receiver 2400 of FIG. 24A. The method 2500 robustly decodes an RF signal. In step 2505, an RF signal is received via a multipath radio channel. In step 2510, the RF signal is converted to a BB signal including a time sequence of corrupted OFDM symbols, which have traveled through a multipath radio channel, causing time and frequency dispersion, and introducing noise and interference. In step 2515, a guard time interval between adjacent OFDM symbols is removed. In step 2520, the time sequence of corrupted OFDM symbols is converted into a frequency domain by performing a FFT on each OFDM symbol in the sequence. In step 2525, a sequence of corrupted complex valued sub-carrier amplitudes is generated based on the converted OFDM symbols. In step 2530, the sequence of corrupted complex valued sub-carrier amplitudes is buffered in a two-dimensional matrix. In step 2535, the sequence of corrupted complex valued sub-carrier amplitudes is partitioned into a two-dimensional array of atomic windows used to perform channel estimation based on the received signal.

Still referring to FIG. 25, in step 2540, varying numbers of adjacent atomic windows are grouped together to create sliding windows. In step 2545, the time sequence of sub-carrier corrupted amplitudes within each sliding window are processed. In step 2550, the results of step 2545 are post-processed to produce a sequence of detected data bits. In step 2555, the sequence of data bits detected by the processing and post-processing of the sliding window symbols are de-interleaved.

Although the features and elements of the invention are described in the embodiments in particular combinations, each feature or element can be used alone without the other features and elements of the embodiments or in various combinations with or without other features and elements of the invention. The methods or flow charts provided in the invention may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs)

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A receiver configured to robustly decode a radio frequency (RF) signal, the receiver comprising:
at least one antenna configured to receive the RF signal;
an RF to base-band (BB) converter electrically coupled to the antenna, the RF to BB converter being configured to convert the RF signal to a BB signal including a time sequence of corrupted orthogonal frequency division multiplexing (OFDM) symbols;
a preliminary processing unit electrically coupled to the RF to BB converter, the preliminary processing unit being configured to convert the time sequence of corrupted OFDM symbols into a frequency domain by performing a fast Fourier transform (FFT) on each OFDM symbol in the sequence after removing a guard time interval between adjacent OFDM symbols, and output a sequence of corrupted complex valued sub-carrier amplitudes; and
a two-dimensional window processing unit electrically coupled to the preliminary processing unit, the two-dimensional window processing unit being configured to buffer the sequence of corrupted complex valued sub-carrier amplitudes, and partition the sequence of corrupted complex valued sub-carrier amplitudes into a two-dimensional array of atomic windows used to perform at least one of channel estimation and equalization.

2. The receiver of claim 1, wherein the OFDM symbols are comprised by the RF signal which travels through a multipath radio channel that causes time and frequency dispersion, and introduces noise and interference.

3. The receiver of claim 1 further comprising:
a de-interleaver configured to de-interleave a sequence of detected data bits output by the multi-dimensional window processing unit.

4. The receiver of claim 1 wherein the two-dimensional window processing unit comprises:
a buffer configured to buffer the sequence of corrupted complex valued sub-carrier amplitudes output by the preliminary processing unit in a two-dimensional matrix;
an atomic window processing unit electrically coupled to the buffer, the atomic window processing unit being configured to partition the two-dimensional matrix into a two-dimensional array of atomic windows;
a sliding window construction and processing unit electrically coupled to the atomic window processing unit, the sliding window construction and processing unit being configured to group together varying numbers of adjacent atomic windows output by the atomic window processing unit to create sliding windows, and process a time sequence of sub-carrier corrupted amplitudes within each of the sliding windows; and
a post-processing unit electrically coupled to the sliding window construction and processing unit.

5. The receiver of claim 4 wherein the sliding window construction and processing unit estimates a channel response of the received signal in time and frequency domains, and the post-processing unit performs subsequent equalization and detection of sub-carrier modulated data associated with the received signal.

6. The receiver of claim 4 wherein the sliding window construction and processing unit performs blind signal separation using independent component analysis (ICA) techniques, and the post-processing unit performs subsequent channel estimation and data detection associated with the received signal.

7. The receiver of claim 4 wherein overlapping sliding windows output by the sliding window construction and processing unit seed the results of processing one sliding window into an adjacent one to produce efficient fast converging and robust estimation of channel and interference suppression.

8. The receiver of claim 4 wherein the results of the sliding windows output by the sliding window construction and processing unit are used to provide information regarding the optimal way to group the atomic windows to construct the sliding windows, whereby the output of the sliding window construction and processing unit is fed back to the sliding window construction and processing unit via a window adaptation input so that the sliding windows may be adaptively created to be optimally matched to the varying channel characteristics.

9. The receiver of claim 1 wherein the sliding window construction and processing unit generates a plurality of fixed-size sliding windows, where each window overlaps somewhat with its neighboring windows.

10. The receiver of claim 9 wherein the overlapping windows are used to seed neighboring windows in a sequence in a time-frequency channel plane, whereby within the sequence, a solution obtained in a prior window seeds the processing in a next window.

11. The receiver of claim 10 wherein the sliding window construction and processing unit uses OFDM channel values determined based on known sequences in the time domain to seed solutions matrices for channel value determination during data periods, whereby OFDM channel values determined during data periods are used to seed solution matrices for channel value determination during known sequences.

12. The receiver of claim 1 wherein the sliding window construction and processing unit uses OFDM channel values determined based on known sequences in the frequency domain to seed solutions matrices for channel value determination during data periods.

13. A wireless transmit/receive unit (WTRU) in which the receiver of claim 1 is incorporated.

14. A base station in which the receiver of claim 1 is incorporated.

15. A two-dimensional window processing unit comprising:
a buffer configured to buffer a sequence of corrupted complex valued sub-carrier amplitudes in a two-dimensional matrix;
an atomic window processing unit electrically coupled to the buffer, the atomic window processing unit being configured to partition the two-dimensional matrix into a two-dimensional array of atomic windows;
a sliding window construction and processing unit electrically coupled to the atomic window processing unit, the sliding window construction and processing unit being configured to group together varying numbers of adjacent atomic windows output by the atomic window processing unit to create sliding windows, and process a time sequence of sub-carrier corrupted amplitudes within each of the sliding windows; and
a post-processing unit electrically coupled to the sliding window construction and processing unit.

16. The two-dimensional window processing unit of claim 15 wherein the sliding window construction and processing unit estimates a channel response of a received signal in time and frequency domains, and the post-processing unit performs subsequent equalization and detection of sub-carrier modulated data associated with the received signal.

17. The two-dimensional window processing unit of claim 15 wherein the sliding window construction and processing unit performs blind signal separation using independent component analysis (ICA) techniques, and the post-processing unit performs subsequent channel estimation and data detection associated with the received signal.

18. The two-dimensional window processing unit of claim 15 wherein overlapping sliding windows output by the sliding window construction and processing unit seed the results of processing one sliding window into an adjacent one to produce efficient fast converging and robust estimation of channel and interference suppression.

19. The two-dimensional window processing unit of claim 15 wherein the results of the sliding windows output by the sliding window construction and processing unit are used to provide information regarding the optimal way to group the atomic windows to construct the sliding windows, whereby the output of the sliding window construction and processing unit is fed back to the sliding window construction and processing unit via a window adaptation input so that the sliding windows may be adaptively created to be optimally matched to the varying channel characteristics.

20. The two-dimensional window processing unit of claim 15 wherein the sliding window construction and processing unit generates a plurality of fixed-size sliding windows, where each window overlaps somewhat with its neighboring windows.

21. The two-dimensional window processing unit of claim 20 wherein the overlapping windows are used to seed neighboring windows in a sequence in a time-frequency channel plane, whereby within the sequence, a solution obtained in a prior window seeds the processing in a next window.

22. The two-dimensional window processing unit of claim 15 wherein the sliding window construction and processing unit uses OFDM channel values determined based on known sequences in the time domain to seed solutions matrices for channel value determination during data periods, whereby OFDM channel values determined during data periods are used to seed solution matrices for channel value determination during known sequences.

23. The two-dimensional window processing unit of claim 15 wherein the sliding window construction and processing unit uses OFDM channel values determined based on known sequences in the frequency domain to seed solutions matrices for channel value determination during data channels.

24. A receiver in which the two-dimensional window processing unit of claim 15 is incorporated.

25. A wireless transmit/receive unit (WTRU) in which the receiver of claim 24 is incorporated.

26. A base station in which the receiver of claim 24 is incorporated.

27. A receiver configured to robustly decode a radio frequency (RF) signal, the receiver comprising:
at least one antenna configured to receive the RF signal;
an RF to base-band (BB) converter electrically coupled to the antenna, the RF to BB converter being configured to convert the RF signal to a BB signal including a time sequence of corrupted orthogonal frequency division multiplexing (OFDM) symbols;
a preliminary processing unit electrically coupled to the RF to BB converter, the preliminary processing unit being configured to convert the time sequence of corrupted OFDM symbols into a frequency domain by performing a fast Fourier transform (FFT) on each OFDM symbol in the sequence after removing a guard time interval between adjacent OFDM symbols, and output a sequence of corrupted complex valued sub-carrier amplitudes; and
a multi-dimensional window processing unit electrically coupled to the preliminary processing unit, the three-dimensional window processing unit being configured to buffer the sequence of corrupted complex valued sub-carrier amplitudes, and partition the sequence of corrupted complex valued sub-carrier amplitudes into a multi-dimensional array of atomic windows used to perform at least one of channel estimation and equalization.

28. The receiver of claim 27, wherein the OFDM symbols are comprised by the RF signal which travels through a multipath radio channel that causes time and frequency dispersion, and introduces noise and interference.

29. The receiver of claim 27 wherein the multi-dimensional array is defined by three dimensions including time, frequency and space.

30. A method of robustly decoding a radio frequency (RF) signal, the method comprising:
receiving the RF signal;
converting the RF signal to a base-band (BB) signal including a time sequence of corrupted orthogonal frequency division multiplexing (OFDM) symbols;
removing a guard time interval between adjacent OFDM symbols;
converting the time sequence of corrupted OFDM symbols into a frequency domain by performing a fast Fourier transform (FFT) on each OFDM symbol in the sequence;
generating a sequence of corrupted complex valued sub-carrier amplitudes based on the converted OFDM symbols;
buffering the sequence of corrupted complex valued sub-carrier amplitudes in a two-dimensional matrix; and
partitioning the sequence of corrupted complex valued sub-carrier amplitudes into a two-dimensional array of atomic windows used to perform channel estimation based on the received signal.

31. The method of claim 30, wherein the OFDM symbols are comprised by the RF signal which travels through a multipath radio channel that causes time and frequency dispersion, and introduces noise and interference.

32. The method of claim 30 further comprising:
de-interleaving a sequence of data bits detected by the processing and post-processing of sliding window symbols.

33. The method of claim 30 further comprising:
grouping together varying numbers of adjacent atomic windows to create sliding windows; and
processing a time sequence of sub-carrier corrupted amplitudes within each sliding window.

34. The method of claim 30 further comprising:
estimating a channel response of the received signal in time and frequency domains, and subsequent equalization and detection of sub-carrier modulated data.

35. The method of claim 30 further comprising:
performing blind signal separation using independent component analysis (ICA) techniques; and
performing subsequent channel estimation and data detection.

36. The method of claim 30 further comprising:
seeding overlapping sliding windows to the results of processing one sliding window into an adjacent one to produce efficient fast converging and robust estimation of channel and interference suppression.

37. The method of claim 30 wherein the results of the sliding windows are used to provide information regarding the optimal way to group the atomic windows to construct the sliding windows, whereby the results of the sliding windows are considered so that the sliding windows may be adaptively created to be optimally matched to the varying channel characteristics.
